(19) United States
(12) Patent Application Publication
(10) Pub. No.: US 2006/0294238 A1
(43) Pub. Date: Dec. 28, 2006

(54) Policy-based hierarchical management of shared resources in a grid environment

(76) Inventors: Vijay K. Naik, Pleasantville, NY (US); David Frederick Bantz, Bedford Hills, NY (US); Nagui Halim, Yorktown Heights, NY (US); Swaminathan Sivasubramanian, Chennai (IN)

Correspondence Address: Thomas A. Beck Esq., 26 Rockledge Lane, New Milford, CT, 06776, US

(21) Appl. No.: 10/320,316

(22) Filed: Dec. 16, 2002

(51) Int. Cl. G06F 15/173

(52) U.S. Cl. 709/226

(57) ABSTRACT

The invention relates to controlling the participation and performance management of a distributed set of resources in a grid environment. The control is achieved by forecasting the behavior of a group of shared resources, their availability and quality of their performance in the presence of external policies governing their usage, and deciding the suitability of their participation in a grid computation. The system also provides services to grid clients with certain minimum levels of service guarantees using resources with uncertainties in their service potentials.

### BACKGROUND OF THE INVENTION

1. Field of the Invention

The present invention relates to controlling the participation and performance management of a distributed set of resources in a grid environment. In particular, this invention relates to forecasting the behavior of a group of shared resources, their availability and quality of their performance in the presence of external policies governing their usage, and deciding the suitability of their participation in a grid computation. The invention also relates to providing services to grid clients with certain minimum levels of service guarantees using resources with uncertainties in their service potentials.

2. Description of the Prior Art

Personal computers represent the majority of the computing resources of the average enterprise. These resources are not utilized all of the time. The present invention recognizes this fact and permits utilization of computing resources through grid-based computation running on virtual machines, which in turn can easily be run on each personal computer in the enterprise.

Grid computing embodies a scheme for managing distributed resources for the purposes of providing simultaneous services to similar types of related and unrelated computations and embodies a scheme for managing distributed resources for the purposes of allocation to parallelizable computations. For these reasons, grid computing is both a topic of current research and an active business opportunity.

Grid computing has its origins in scientific and engineering related areas where it fills the need to discover resources necessary for solving large scale problems and to manage computations spread over a large number of distributed resources. The fundamentals of grid computing are described in The Grid: Blueprint for a New Computing Infrastructure, I. Foster, C. Kesselman, (eds.), Morgan Kaufmann, 1999. The authors wrote: “A computational grid is a hardware and software infrastructure that provides dependable, consistent, pervasive, and inexpensive access to high-end computational capabilities.”

In a typical grid environment, grid management services are provided to mask resource management related issues from the grid user. To the grid user, resources appear as if they are part of a homogeneous system and are managed in a dedicated manner for the user, when in fact the resources may be widely distributed, loosely coupled, and may have variable availability and response time characteristics.

As described by I. Foster, C. Kesselman, J. M. Nick, S. Tuecke, in “The Physiology of the Grid: An Open Grid Services Architecture for Distributed Systems Integration,” currently available on the Web at http://www.globus.org/research/papers/ogsa.pdf and by I. Foster, C. Kesselman, and S. Tuecke, in “The Anatomy of the Grid: Enabling Scalable Virtual Organizations,” International Journal of High Performance Computing Applications, 15(3), 200-222, 2001, grid management services attempt to keep track of the resources and services delivered and try to match the demand with the supply. As long as the available supply of resources exceeds the demand, the grid services only have to manage the mapping of the resources to the consumers of the resources.

Today many efforts are focused on streamlining the process of searching for grid resources and are focused towards managing and monitoring the resources, so that meaningful service level agreements can be set and achieved. (See, for example, K. Czajkowski, I. Foster, C. Kesselman, S. Martin, W. Smith, and S. Tuecke, “A Resource Management Architecture for Metacomputing Systems,” In. Proc. IPPS/SPDP '98, Workshop on Job Scheduling Strategies for Parallel Processing, pp. 62-82, 1998; B. Lee and J. B. Weissman, “An Adaptive Service Grid Architecture Using Dynamic Replica Management”, In Proc. 2^{nd} Intl. Workshop on Grid Computing, November 2001; R. Buyya, D. Abramson, J. Giddy, “Nimrod/G: An Architecture for a Resource Management and Scheduling System in a Global Computational Grid,” In Proc. of The 4th International Conference on High Performance Computing in Asia-Pacific Region, May 2000, Beijing; K. Krauter, R. Buyya, and M. Maheswaran, “A Taxonomy and Survey of Grid Resource Management Systems for Distributed Computing,” International Journal of Software. Practice and Experience, May 2002.)

Discovering grid resources and managing and monitoring these resources plays out well when the resources are dedicated for delivering grid services. Resource unpredictability is due to the availability and robustness of resources in the presence of faults. This can be managed by using passive or active monitors that keep track of the health of the resources and then by making decisions based on the collective pulse.

The transparent discovery and deployment inherent in Grid systems make them ideal for leveraging idle resources that may be available in an organization. For the same reasons they are also suitable for offering services that can be run ubiquitously or whose state can be captured easily. Transaction based services are an example of such services. In such cases, business processes are run using user-supplied data and/or using data stored in databases. The resulting data from these computations is either sent back to the users and/or stored back in a database. All the state related information is stored in the database and the business logic remains stateless. These types of services can be run on any capable computing resource that can access user supplied data and the data stored in the databases. The resources need not be dedicated to run these services, but can be normally deployed for other purposes and are available from time to time to run these types of services.

Although the transparent discovery and deployment concepts inherent in grids make them suitable for leveraging unused resources in an organization, some practical problems need to be overcome first. One problem relates to security and another problem relates to the prioritized sharing of resources. When a resource is shared, native applications need to be isolated from grid applications for security and privacy concerns. In the instant invention, this issue is addressed by making use of virtual machines deployed on top of hypervisors. The second problem noted above is addressed by allowing users or owners or administrators of shared resources to set policies. These policies govern the manner in which the resources are to be shared and the manner in which priorities are to be set among the grid and the native applications.

The instant invention describes mechanisms to serve grid clients in the presence of the user-defined policies and unpredictable native applications workload on the shared resources.

The present invention relates to the case where the grid resources are not dedicated towards providing grid services but rather are shared with another workload. These resources are characterized by high variability in their instantaneous availability for grid computations as compared to the variability of their uptime. Although the instantaneous availability varies, the availability of these resources is high when averaged over a period of time.

Examples of resources that can be shared with grid computations include notebook PCs, desktop PCs and interactive workstations, backend servers, and web servers. Desktop PCs and interactive workstations are deployed for running interactive applications on behalf of a single user. (For purposes of the description of the present invention, as used herein, the terms “notebook PCs,” “desktop system,” “desktop PC,” and “interactive workstation” are used interchangeably.)

Interactive response time of desktop PCs is of prime importance. However, users do not use such machines all the time. In fact, many observations have confirmed that these types of systems are in use less than 10% of the time. When they are not running interactive applications, they can be used to run grid computations. Since interactive applications may be invoked randomly and without notice, a key challenge for grid systems is in determining when to run the computations. Similarly, backend servers are used to run backend applications, which are typically run periodically. When they are not run, the server resources are available for grid computations.

A similar effort of providing a computing infrastructure for untrusted code is studied by D. Reed, I. Pratt, P. Menage, S. Early, N. Stratford, and described in “Xenoservers: Accounted Execution of Untrusted Code,” in Proc. IEEE Hot Topics in Operating Systems VII, March. 1999. This work emphasizes providing a secure infrastructure for running untrusted applications and provides mechanisms for accounting the secure infrastructure. However, the above-referenced work does not allow a “policy based sharing of resources,” which is one of the key features of the present invention.

The basic objectives of the present invention are similar to other Distributed Processing Systems (DPS) such as Condor (described by Michael Litzkow, Miron Livny, and Matt Mutka, “Condor—A Hunter of Idle Workstations”, In Proc. 8th International Conference of Distributed Computing Systems, pp. 104-111, June, 1988) and Legion (described by A. S. Grimshaw, et. al., “The Legion Vision of a Worldwide Virtual Computer,” Communications of the ACM, January 1997, 40(1)) in terms of utilizing the computation power of idle workstations.

The invention described herein offers better resource control than previously defined systems using a hierarchical resource management structure that predicts future events and the state of the resources in the future. It applies policies to the forecasted future state of resources and predicts the quality of those resources and quality of the grid services deployed on those resources. In the instant invention, resources are shared exclusively using Virtual machines, which are self-contained and can be easily managed by another operating system (OS).

A PC-based grid infrastructure, called DCGrid Platform, is built by Entropia (See “DCGrid Platform” currently at http://www.entropia.com). “DCGrid Platform” runs grid applications using idle cycles from desktop PCs. It provides a platform for executing native Win-32 applications. The platform isolates grid applications from the native applications through an undisclosed secure technology and provides job-scheduling schemes on the desktop PCs to preserve the interactivity of the desktop systems. “DCGrid Platform,” as it presently exists does not provide a hierarchical policy-based decision making system as described in the instant invention. It does not serve grid client requests taking into account quality of service requirements. Furthermore, DCGrid Platform does not make use of virtual machines as described in the instant invention.

The use of virtual machines, as described in the instant invention, preserves the integrity of the desktop systems and provides a computational environment in which each virtual machine can be treated as an individual machine by itself. This enables the user to run multiplatform applications (e.g., users can run Windows or Linux applications in different virtual machines) and services, such as web services, in a straightforward manner.

It is to be noted that the invention is a significant enabler for e-Business on Demand, because it makes resources available for the remote provisioning of services that are not currently available. It makes a model possible where e-Business on Demand is provisioned from the customer's interactive workstations and idle servers at a significant cost reduction for the service provider.

### SUMMARY OF THE INVENTION

The present invention embodies a grid composed of shared resources from computing systems that are primarily deployed for performing non-grid related computations. These include desktop systems whose primary purpose is to serve interactive computations, backend servers whose primary purpose is to run backend office/department applications, web servers whose primary purpose is to serve web pages, and grid servers that may participate in multiple grid computations.

The resources on such systems mentioned above are to be used for serving grid client requests according to the policies set by owner/user of the computing system. At any given instant, multiple local policies may exist and these may dynamically affect the availability of resources to the grid. Even if enough resources are available from multiple computing systems for performing grid computations, the dynamically varying availability conditions make the grid management task challenging.

The following are the key components of the present invention:
1. This invention describes methods and apparatus for sharing a distributed set of resources while conforming to local resource usage policies.
2. This invention describes an apparatus for predicting future events and the state of the resources by using targeted monitoring and analysis.
3. This invention describes methods for increasing the accuracy of the forecast about the future state of the computing resources. These methods are based the analysis and correlation techniques among the events affecting multiple computing systems.
4. This invention describes an apparatus for centralized application of policies to predict the state of the distributed resources that are to be shared.
5. This invention describes methods for reducing the uncertainties in the availability of individual resources because of inaccuracies in the forecasting models or because of the unexpected changes in the policies by using aggregation techniques and by using just-in-time scheduling and routing of grid client requests to the best available grid resources.
6. This invention describes a hierarchical grid resource management system that provides grid services with certain minimum level of service guarantees using resources that have inherent uncertainties in their predicted quality available for grid computations.

The present invention describes a hierarchical grid resource management system and client request management system that performs the above described tasks without the grid clients having any knowledge of underlying uncertainties. The grid clients do not have to know the name or location of the actual resources used. These actions are performed transparently to the grid clients and the grid clients are oblivious to the dynamic changes in the availability of grid resources.

An important aspect of the present invention is that it relates to a grid composed of desktop PC resources that are used for serving the grid client requests according to policies set by each desktop owner/user. An example of one such policy is to allow a desktop to participate in a grid computation only when no interactive workload is being processed on the desktop. Another policy may be to allow a desktop to participate in grid computations only during certain time of the day; and so on. Thus, at any given instant, multiple local policies may exist and these may dynamically affect the availability of a desktop resource to the grid.

In addition to the desktop PC resources, the grid management system described in the instant invention can incorporate resources from backend servers, web servers, and grid servers.

The present invention describes a grid management system that: (1) allows dynamic association and disassociation of shared resources with the grid; (2) performs dynamic aggregation of shared resources to satisfy grid client requests; and (3) facilitates efficient means for routing of grid client requests to appropriate resources according to their availability.

As noted above, the actions spelled out in (1), (2) and (3) immediately above, are performed transparently to the grid clients and the grid clients are oblivious to the dynamic changes in the availability of grid resources.

### BRIEF DESCRIPTION OF THE DRAWINGS

The present invention will be more fully understood by reference to the following detailed description of the preferred embodiment of the present invention when read in conjunction with the accompanying drawings, in which reference characters refer to like parts throughout the views and in which:

FIG. 1 is a block diagram showing the overall architecture of the policy-based hierarchical grid resource management framework of the present invention.

FIG. 2 is a detailed view of the components of a desktop-based resource.

FIG. 3 is a server resource shared among multiple grids.

FIG. 4 is the organization of the functional components of a first level resource manager.

FIG. 5 depicts the details of an intermediate level grid resource manager.

FIG. 6 depicts the detailed structure of a top level grid resource manager.

FIG. 7 is a sample format of a Table of logical service.

FIG. 8 is a sample format of a Table of physical service.

FIG. 9 depicts the details of a grid service request processor (GSRP).

### DETAILED DESCRIPTION OF THE PREFERRED EMBODIMENT

A preferred embodiment of the present invention consisting of a description of the methods employed and the necessary apparatus will now be described.

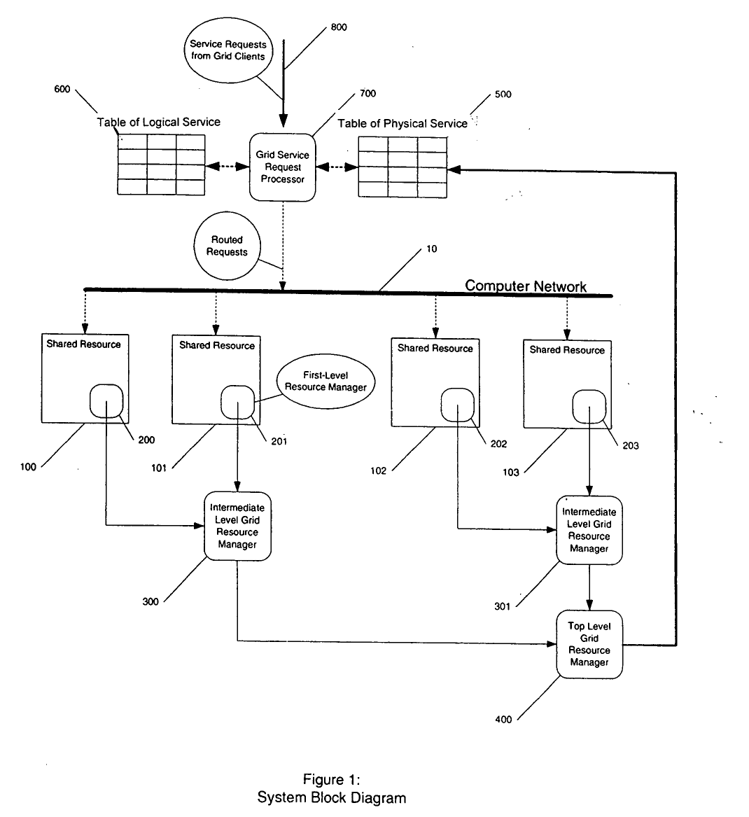

FIG. 1 shows the overall architecture of the policy-based hierarchical grid resource management framework. The main components of this architecture are: a set of shared resources (100, 101, 102, and 103); a hierarchy of resource managers formed by First-level resource managers (200, 201, 202, and 203), Intermediate-level Grid Resource Managers (300 and 301), and a Top-level Grid Resource Manager 400; Table of physical services 500 and Table of logical services 600; and Grid Service Request Processor 700.

Four shared resources (100, 101, 102, and 103) are interconnected with one another and with the rest of the control structure via the Computer Network 10. Examples of a shared resource are a desktop system such as a PC or a workstation, a backend server, a Web server, a grid server, or any other computing system that can be shared by multiple tasks.

Each shared resource is equipped with a First-level resource manager (200, 201, 202, and 203) that is part of the hierarchical grid management infrastructure and provides policy management and control at the resource level.

As will be discussed subsequently, a First-level resource manager monitors the state of the local resources, gathers policy related data, performs analysis, and communicates data and results from analysis to a resource manager at the next level of management hierarchy.

In a generic embodiment, there may be one or more levels of intermediate-level Grid Resource Managers (iGRM). However, in special cases there may not be any iGRMs. In such cases, the First-level resource managers communicate directly with a top-level Grid Resource Manager (tGRM).

In FIG. 1, one level of iGRMs is shown. This consists of two iGRMs, 300 and 301. An iGRM communicates data and results from analysis to another iGRM at the next higher level or to the tGRM such as 400 in FIG. 1.

The hierarchical control and management system consists of First-level resource managers at the lowest level, zero or more levels of iGRMs, and a tGRM at the top level. The number of intermediate levels in the hierarchy as well as the number of lower-level resource managers feeding to an iGRM or to a tGRM depends on the amount of data to be analyzed at each level and the complexity of the analysis. Typically, with fewer lower-level resource managers per higher-level resource manager, there is less analysis to be performed at each level. However, this increases the total number of levels in the management hierarchy of the system. Each additional level adds to overhead and sequential computations in the decision making process. Taking these trade-offs into considerations, a person skilled in the art can make a judicious choice of the number of levels in the hierarchy and the number of lower-level resource managers per higher-level resource manager.

In accordance with the present invention, the hierarchical control and resource management system gathers and analyzes data related to the state of the resources and the policies defined by the resource owners. Collectively, the resource managers analyze the monitored state data for identifying patterns and correlations in their behavior to forecast the state of each resource at various time intervals in the future.

For example, the forecast for a desktop resource may indicate the CPU utilization, because of the interactive workload, to be less than 10% in the next 5 minutes, between about 10% and 50% in the range of 5 and 15 minutes, and between about 50% and 80% in the range of 15 minutes and 30 minutes from now. Similarly, for a backend server, the forecast may characterize the state of the system as a function of running backend office applications; for a Web server it may characterize the state of the server as a function of serving web pages; and for a Grid server, it may forecast the state of the server as a result of previously scheduled grid computation. The forecast may characterize the state of the resource in terms of CPU utilization, memory utilization, paging activity, disk access, network access, or any other performance limiting criterion that can be monitored and quantified. The forecasting is performed continuously in an on-going manner and, in each successive iteration, a previous forecast may be updated.

Many techniques for forecasting exist, for example as described in Forecasting and Time Series Analysis, Douglas C. Montgomery and Lynwood A. Johnson, McGraw-Hill, 1976. The instant invention is not inclusive of new forecasting means; rather, all forecasting means of adequate accuracy are equally applicable. Forecasting means are required for the instant invention to allow accurate predictions of the state of the resource, such as desktop or backend server resources.

Once the future state of a resource is identified, relevant policies can be applied to predict the availability and the quality of the resource for scheduling grid computations at a future time interval. For example, consider a desktop resource with the following policy governing when grid computations can be performed on that resource: grid computations are to be allowed only when interactive workload utilizes less than 10% of the available CPU cycles. This policy is evaluated against the predicted state of the desktop at various future time intervals and, in one embodiment, those intervals with less than 10% CPU utilization due to interactive workload are marked as available for grid computations with high probability. The time intervals, if any, with interactive workload CPU utilization between 10% and 25% are marked as available with low probability and those with CPU utilizations above 25% are marked as unavailable time intervals. The associated probabilities are determined based on the uncertainties in the predictions.

Exemplary of the determination of the identification of the availability and quality of a resource for scheduling of grid computations at a future time, the predicted states of a resource can be represented as a sequence of numbers between 0.0 and 100.0, one number for each interval for which a prediction is available. Each number represents a percentage CPU utilization. A policy can be represented as an iterative computation, one iteration for each interval for which a prediction is available. The computation consists of a comparison between the predicted state of the resource and a threshold value, for example, 10.0 in accord with the previous description. The output of the computation is a sequence of numbers between 0.0 and 1.0 representing, for each time interval, the degree to which the predicted state of the resource is in accord with the policy. For example, if the predicted state is 17%, the output value could be 0.3 whereas if the predicted state is 5% the output value could be 0.9, representing a high degree of agreement between the policy and the predicted state.

It is emphasized that policies can be represented in alternative ways, for example as a textual entity or rule. Such rules can be interpreted by software designed specifically for rule interpretation. One example is the Application Building and Learning Environment Toolkit, currently available from www.alphaworks.ibm.com.

Availability of a resource for grid computations does not imply that any grid service can be deployed on that resource. Several factors determine which of the grid services can be deployed on a resource. A discussion of these pertinent factors follows.

In a grid environment, more than one type of grid service may need to be deployed. This may be because the grid clients may be interested in more than one type of grid service. In addition, some of the grid services may be composed using more than one type of elementary grid services and some may have dependencies on other services.

Even after satisfying any service dependency constraints, there may be resource dependency constraints that need to be evaluated before determining if a service can be deployed on a given resource. For example, in order to run properly, a grid service may require certain type of hardware (e.g., 2.4 GHz Intel Pentium 4 processor) or certain type or version of OS (e.g., Microsoft Windows 2000 with Service Pack 2). Moreover, certain level of quality-of-service (QoS) may be associated with an instance of a grid service. For example, a preferred set of grid clients may be guaranteed a certain response time. To realize this, an instance of that service must be deployed such that the promised QoS is realized.

Generally the quality-of-service associated with a grid service depends on the quality of the resource on which it is deployed. Thus, availability of a resource for grid computations does not imply that any grid service can be deployed on that resource. Both the resource-related policies and grid-related policies may have to be taken into account, as described in the following.
(1) The effect of resource policies: There may be service specific policies associated with a resource that govern which services can be deployed on that resource and when these services can be deployed. For example, a user-defined policy may allow services requiring databases access over the network only between 6 PM and 6 AM on weekdays.
(2) The effect of grid policies: The predicted quality of resource must be sufficient to realize the quality-of-service from the deployed service. For example, in case of a backend server, the predications may indicate high network access during certain time interval, by the locally scheduled backend office applications. This implies inferior QoS for a grid application requiring network access during that period. If this QoS is not acceptable, then the grid service should not be deployed on that resource during that time period.

Thus, deploying a service on a resource depends on the availability of that resource, the quality of that resource, and on the resource per se and grid-level policies in effect at the time the service is to be deployed.

The tGRM makes the decisions about when to deploy a new instance of a grid service and what resources to use to deploy that service. The tGRM takes into account the patterns observed in the service requests arriving from grid clients and grid policies associated with each type of request. From these, it makes predictions about the type and arrival rates of future requests from grid clients. Using these predictions, the tGRM determines if additional service instances for any of the offered services need to be deployed. A new service instance may need to be deployed, for example, to maintain the response time within certain agreed upon limits. For each such service instance, it identifies the resources on which to deploy that instance. The resources are selected based on the quality of resource availability predictions for the appropriate time interval. These predictions are made as described earlier.

The services instantiated by tGRM in response to expected service requests from grid clients, as described above, are referred to as physical services. Because the resources on which they are deployed are not dedicated to run these services and may be withdrawn at a moment's notice, the tGRM over-provisions resources by deploying more physical service instances than would be necessary in a dedicated and reliable environment. The details of this are described subsequently.

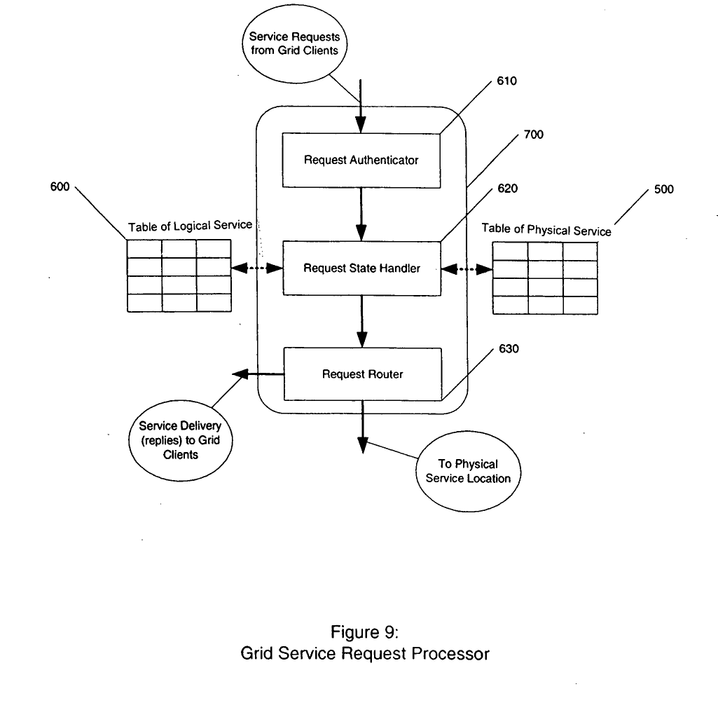

All grid clients send their requests to a single address (URL) regardless of the type of service they are requesting or the quality-of-service they expect. Referring to FIG. 9, these requests are received by the Grid Service Request Processor (GSRP), (700). After authenticating a request, GSRP assigns that request to one of the logical service instances that is capable of providing the requested type of service with the agreed upon quality of service. The assignment is made using Table of logical services, (600). A mapping function is used to map the logical service instance onto one of the many physical service instances that are capable of providing the service. The details about the mapping function are described later. The physical service instances are listed in the Table of Physical Services, (500). Also listed in this table are weights to be used by the mapping function in determining the actual physical service instance to use for servicing a request. These weights are updated continuously by tGRM using the predictions about the state of the available resources, the resource related policies, the expected demand on the grid services, and the grid policies.

When a new request arrives, GSRP consults the two tables (500) and (600) and, using the mapping function, it decides on the actual physical service instance to use. It then routes the request to that service instance, while maintaining the state of that request as “assigned”. After servicing the request, the reply is sent back to GSRP, which then returns the reply to the appropriate grid client after updating request state to “processed.”

If for some reason, the service instance does not process the request after the request is assigned to it (e.g., if the underlying resource is withdrawn from participation in the grid computations), GSRP reassigns the request to another physical service instance that provides the same service. The request is assigned in this manner until its state is changed to “processed.”

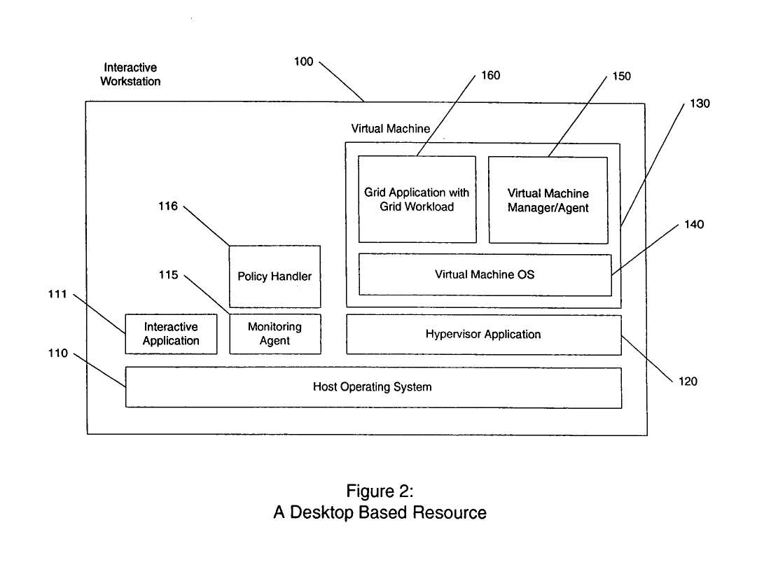

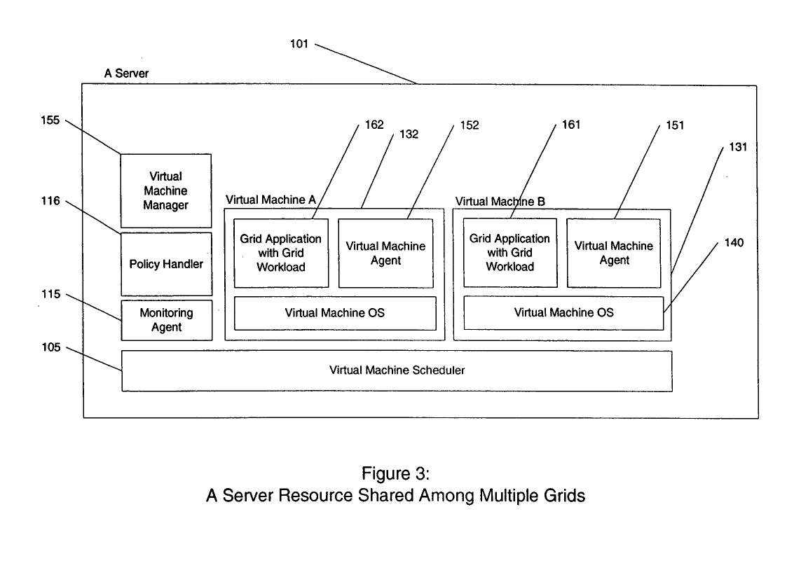

FIGS. 2 and 3 illustrate the typical organization of shared resources. These resources have nominal purposes such as supporting interactive applications or running backend office applications, respectively. But their underutilized resources may be used for grid computations according to user-defined policies.

FIG. 2 illustrates the components of a desktop-based resource such as an interactive workstation. Primary purpose of such a resource is to perform interactive computations. When the resource is not used for interactive computations or is not based on the governing policies, the desktop-based resource is allowed to participate in grid computations. At the lowest level of interactive workstation (100) is host Operating System (Host OS) (110) that supports one or more interactive applications (111), Monitoring Agent (115), and Policy Handler (116). The Host OS also supports a hypervisor application (120), which in turn supports virtual machine (VM) (130). The virtual machine contains a virtual machine Operating System (VM OS) (140), which supports grid applications that handle grid workload (160). The VM OS also supports Virtual Machine Manager (VMM) and/or Virtual Machine Agent (VMA) (150).

Host OS 110 and VM OS (140) contain communications function permitting applications using Host OS 110 and VM OS (140) to communicate. In this manner, it can be seen that the Monitoring Agent (115) and Policy Handler (116) can communicate with VMM/VMA (150) running inside the VM (130). All three components (115, 116, and 150) can also communicate with Grid Applications (160) and with the rest of grid resource management system and the Grid Service Request Processor.

Monitoring Agent (115) uses the functions and facilities of Host OS (110) to obtain information about the utilization of elementary resources in desktop system by all software components supported by the Host OS (110). The elementary resources include CPU, memory, pages in the memory, hard drive, network, and any other resource of interest. The actual information gathered by Monitoring Agent (115) depends on the policies enforced by Policy Handler (116). Monitoring Agent (115) communicates the monitored state information to Policy Handler (116) and to VMM (150).

The Policy Hander (116) is a component for defining, updating, storing, and accessing grid related policies. These policies are defined by the user or the administrator who controls the desktop usage. The Policy Hander may also enforce the policies.

In one embodiment of this architecture, Policy Handler (116) evaluates the local policies using the current state information. Whenever the current state of a monitored resource crosses a threshold as defined by a policy, Policy Handler (116) issues a command to VMM (150). Depending on the policy, the command may require the VMM to stop participating in grid computations altogether or to stop deploying certain types of grid services or to reduce the usage of a particular resource.

In another embodiment, Policy Hander (116) hands over the policies to VMM (150), which evaluates the policies and enforces them.

Although interactive workstation (100) is described with one hypervisor containing one virtual machine, it is possible to for the interactive workstation to support multiple hypervisors each supporting one or more virtual machines. When there are multiple virtual machines in an interactive workstation, one of the virtual machines is chosen to contain the virtual machine manager and the rest of the virtual machines run only a virtual machine agent. The virtual machine manager controls its local virtual machine as well as coordinates with the rest of the grid resource management hierarchy, whereas a virtual machine agent only controls its local virtual machine.

The First-level resource manager consists of the Monitoring Agent (115), Policy Handler (116), VMM (150), and any Virtual Machine Agents. The details of this component are described subsequently.

FIG. 3 shows resources of shared among multiple grids. Unlike the interactive workstation shown in FIG. 2, Server (101) has no interactive applications. Server (101) contains a Monitoring Agent (115), Policy Hander (116), and Virtual Machine Manager (VMM) (155) all in a separate Virtual Machine (VM) with its own Virtual Machine OS.

Using the communication functions of the VM OS, these components can communicate with other components outside of their VM. The server resources are shared among multiple grids by creating a separate VM, one for each grid. FIG. 3 shows two grid VMs (131) and (132). The VMs in the Server are scheduled by the Virtual Machine Scheduler (105). Each VM contains a Virtual Machine Operating System (VM OS) (140). Each grid VM has a Virtual Machine Agent (VMA) (151), which communicates with VMM (155). Each grid VM also contains one or more grid applications such as (161), each supporting grid workload.

The policies governing how the server resources are to be shared among multiple grids are set in Policy Handler (116). The utilization of elementary resources by each VM is monitored by Monitoring Agent (115). This information is communicated to VMM (155), which communicates with VMAs (151) and (152) and with the rest of grid resource management hierarchy. In the case of Server (101), Monitoring Agent (115), Policy Handler (116), VMAs (151), (152), and VMM (155) together form the First-level resource manager.

Although not shown using separate figures, similar organizations are realized in the case of backend servers or web servers for sharing their resources with one or more grids.

In the case of backend servers, the resources are shared with backend applications and, in the case of web servers, the sharing is with the HTTP servers and/or with web application servers. In each case, policies are set to govern how the resources are to be shared. Similar to the interactive workstation or the server, the grid applications are run within a Virtual Machine with its own operating system and a Virtual Machine Agent.

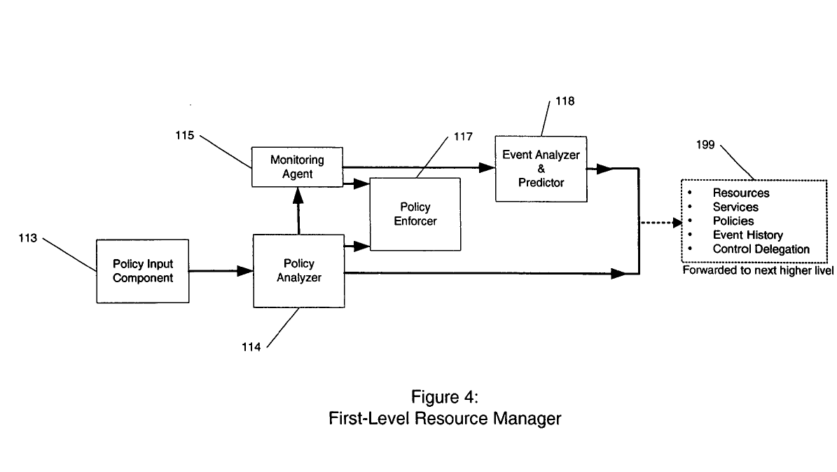

Shown in FIG. 4 is an organization of the functional components of a First-level resource manager. As described earlier, a First-level resource manager forms the lowest level of the hierarchical grid resource management system presented in this invention. It resides on a computing system such as a desktop PC, a backend server, a grid server, or a web server and controls sharing of the resources on that system in grid computations.

Policy Input Component (113) is the component where the users or administrators of a computing system define policies for sharing the resources of the system with grid computations. The policies may be specified using parameters that may be monitored, measured, or computed. A policy may make use of any condition or event that is meaningful and relevant to the users or the administrators. The policies may also be formed by combining simpler policies. For example, a policy may specify upper limits on the utilizations of elementary resources for sharing to take place; a policy may specify a time of the day or week when sharing can occur; yet another policy may specify sharing only when certain applications are not running. Administrators may also specify policies that apply to a group of computing resources such as a group of desktops or a group of servers or a combination there of. For example, one such group policy may allow participation of the least utilized server from a group of four backend servers.

Policy Analyzer (114) analyzes policies defined for that computing system. This component breaks down complex policies into simpler basic policies and from that it derives combinations of events that can lead to the conditions for activating the policies. From this analysis, it determines the resources and properties to monitor. Policy Input Component (113) and Policy Analyzer (114) are part of the Policy Handler (116) shown in FIGS. 2 and 3.

Monitoring Agent (115) monitors the usage of specified elementary resources by any or all of the software components, including the virtual machines running in a computing system. The actual resources and their properties to be monitored depend on the defined policies. Monitoring Agent (115) obtains this information from Policy Analyzer (114). Shown in FIGS. 2 and 3 are instances of Monitoring Agent in the case of an interactive workstation and a server, respectively. A more detailed embodiment of a Monitoring Agent is described in a patent application, entitled “Enabling a Guest Virtual Machine in a Windows Environment for Policy-Based participation in Grid Computations” filed concurrently with the instant application on Dec. 13, 2002, the contents of which are hereby incorporated by reference herein.

Policy Enforcer (117) ensures that existing policies are enforced. This is done by examining the current state of the system as observed by Monitoring Agent (115) and applying the current set of policies. Policy Enforcer (117) considers only the current state of the system and/or the current state of the elementary resources. It does not consider the future state or policies applicable in the future.

For example, if a current policy for an interactive workstation calls for no participation in grid computations whenever any interactive applications are active, the Policy Enforcer prevents any grid computations from taking place whenever this condition is met. The Policy Enforcer may be part of the Policy Handler, it may be a component of the Virtual Machine Manager (VMM), or it may be a component of Virtual Machine Agents (VMA) shown in FIGS. 2 and 3. In another embodiment, the functionality of the Policy Enforcer may be spread among all of these entities.

Event Analyzer and Predictor (118) receives and accumulates events monitored by Monitoring Agent (115). It continuously analyzes past and present events to project the state of the monitored resources or of the software components at various time intervals in the future. The span of the time intervals created depends on the accuracy of monitoring, the accuracy of the analysis and on the nature of the policies. For example, the time intervals considered may be next 1 minute, from 1 minute till the end of 5 minutes from now, from 5 minutes till the end of 15 minutes from now, and so on. In general, the forecast about the state of a resource is less accurate for an interval further out into the future than for an interval closer to the present time. For this reason the forecasts are continuously updated as time advances and new monitored data becomes available.

Event Analyzer and Predicator (118) may make use of variety techniques for performing the predictions. One such technique is Time Series Analysis. Another technique is Fourier Analysis. Yet another technique is Spectral Analysis. An embodiment based on Time Series Analysis is disclosed in the co-pending application, entitled “Enabling a Guest Virtual Machine in a Windows Environment for Policy-Based participation in Grid Computations” referred to above.

Event Analyzer and Predictor (118) is a component of either the Policy Handler or the Virtual Machine Manager (VMM) or both. It is advantageous to run a simpler form of this component in the Policy Handler prior to the instantiation of the virtual machines on a system. Once at least one virtual machine is instantiated, a more complex form of the Event Analyzer and Predictor can be deployed in the VMM to control the sharing.

The output from the Event Analyzer and Predictor (118) is the forecast about future events affecting the state of various resources and of software components in the computing system. As discussed above, these forecasts are computed for multiple time intervals into the future. These predictions along with the information about the current state of the resources, the state of grid services, any changes in the defined policies are forwarded to the next level in the grid resource management hierarchy. This may also include control delegation information. By default, the First-level resource manager makes the policy enforcement decisions for the local system. It also decides on the type of the grid services to deploy. However, it can delegate this authority to the higher levels of the grid management hierarchy by relaying the appropriate Control Delegation information to the next higher level. The collection of information sent to the next higher level is shown in Block (199) in FIG. 4.

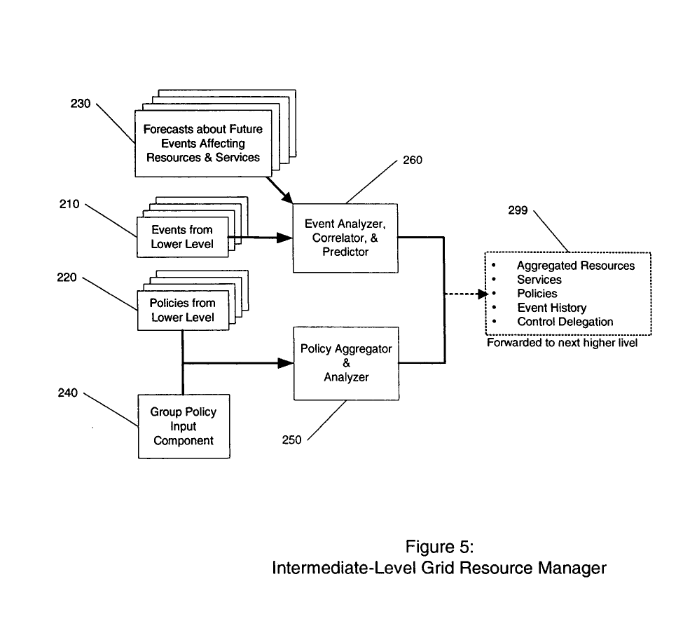

FIG. 5 shows the details of the Intermediate-Level Grid Resource Manager (iGRM). It receives input from multiple First-level Resource Managers. The input includes: (1) monitored events (possibly consolidated) (210) from the lower levels; (2) changes in the policies defined at the lower levels (220); and (3) forecasts about future events affecting the resources and services of interest, (230). Also input to iGRM are the group policy parameters applicable at this level. These are input through Group Policy Input Component (240).

Policy Aggregator and Analyzer (250) collects the policy information from the lower levels as well as the group policy parameters. As in the case of Policy Analyzer (114) of FIG. 4, this component breaks down complex policies into simpler forms. It also aggregates and classifies policies to simplify the task performed by the Top-level Grid Resource Manager (tGRM) in evaluating the effects of the policies in the future time intervals.

Event Analyzer, Correlator, and Predictor (260) collects and further consolidates events gathered at the lower levels. It also receives the forecasts made at the lower levels about the future events at various time intervals. It analyzes the information collectively and attempts to correlate events occurring across the computing systems. For example, it may determine that during certain time intervals of the day, the idle time of two desktop systems are correlated and at other times they are anti-correlated. In another case, it find that when a certain application is active on one system, one or more other systems may become idle and stay idle for the duration of the time that application is active. Such information helps in improving the accuracy of predictions about future events and/or the predictions about the future state of the systems.

The form of the output from iGRM is similar to the output from a First-level Resource Manager. It includes (potentially improved) forecasts about future events that affect the performance of the shared resources and software components. These forecasts are made for various time intervals into the future. In addition, the output from iGRM also includes information about any changes in the defined policies and group policies, consolidated events, current state of the resources and services on the systems in the domain managed by that iGRM, and any changes in the delegation of control information. In FIG. 5, this is shown in Block (299).

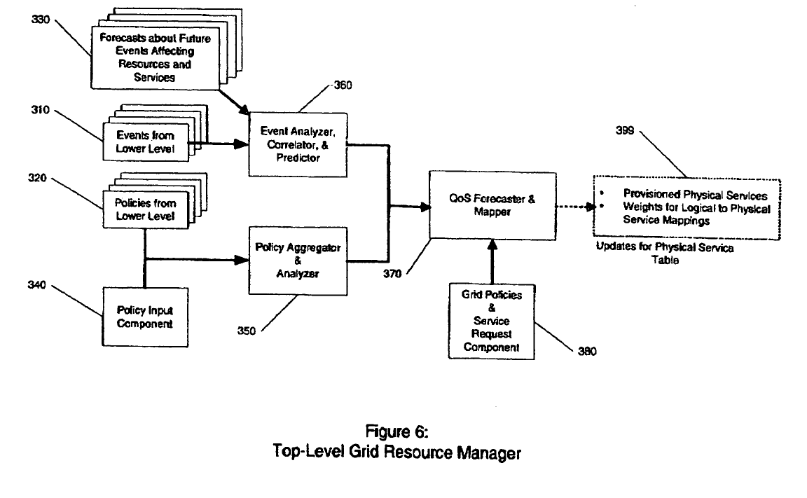

FIG. 6 shows the detailed structure of the Top-level Grid Resource Manager (tGRM). As in the case of iGRM, it receives input from multiple resource managers on the lower levels. The input includes: (1) monitored events (possibly consolidated) (310) from the lower levels; (2) changes in the policies defined at the lower levels (320); and (3) forecasts about future events affecting the performance of the resources and services of interest, (330). Also input to tGRM are the group policy parameters applicable at this level. These are input through the Group Policy Input Component (340).

Using the above described input to tGRM, Policy Aggregator and Analyzer (350) and Event Analyzer, Correlator, and Predictor (360) perform functions similar to their counterparts in the iGRM.

The predicted future events at various time intervals, their effects on the performance of shared resources and other software components, policies and related parameters are all input to Quality-of-Service (QoS) Forecaster and Mapper (370). Also input to this component are the current grid policies and the patterns observed in service requests from grid clients. This is done using Grid Policy and Service Request Component (380). For each system for which forecast data exists, the QoS Forecaster and Mapper (370) applies the policies applicable on that system for the corresponding time interval and computes the predicted state of each shared resource on that system for that time interval. This is repeated for each time interval for which there is data. These predicted states determine the quality of resource (QoR) at a future time. QoR is measured in terms of the fraction of a normalized resource available for grid computations.

For example, the quality of CPU processor may be normalized with respect to the quality of a 2.4 GHz Intel Pentium-4 Processor, which may be defined as unit CPU QoR. If only 25% of such a processor is predicted to be available at a certain time interval, then the predicted QoR of that CPU is said to be 0.25. If a CPU resource is other than Pentium 4, then the available CPU cycles are normalized with respect to Pentium-4. For example, a CPU resource that is half as fast as a Pentium-4 and that is able to deliver up to 40% of its cycles for grid computations is said to have a CPU QoR of 0.2.

QoS Forecaster and Mapper (370) also makes projections about future requests from grid clients for each type of grid service. These projections include projections about the arrival rates as well as the expected quality of service by each arriving request. One measure of QoS is the response time; i.e., the time it takes to process and send back the response after receiving a request. Based on these projections, it determines the number of service instances of that type to deploy. This is done for each time interval for which it has the relevant data available. For each service instance to deploy, it selects appropriate resources based on the requirements of the service as well as the availability of that resource to run that service during a given time interval. The QoR associated with a resource affects the QoS of the service supported by the resource. This is taken into account while selecting the resource.

To deploy service instances on selected physical resources, QoS Forecaster and Mapper issues commands. These commands are transmitted down the resource management hierarchy and are ultimately executed by the VMAs or VMMs on a virtual machine. The service instances thus deployed are referred to as physical service instances.

The actual QoS delivered by a physical service instance depends on the QoR at the time the service is delivered. This in turn depends on the actual events affecting the resource and the policies in effect on that system. The prediction mechanisms described above tries to predict such events and the effects of the policies on the availability and the performance of the resources, as accurately as possible. To further reduce the effects of inaccuracies in the predictions or the effect of uncertainties in the forecasts, the QoS Forecaster and Mapper 370 computes a set of weights for each physical service instance. As described subsequently, the weight is computed partly based on the expected QoS from that service instance. For example, if a physical service instance is deployed on an unreliable resource or if the associated policies regarding sharing are stringent or if the QoR is predicted to be poor for the resources on which the service instance is deployed, then a low weight is assigned to that service instance.

As noted above, a QoS associated with the physical service instances cannot be guaranteed when the service is deployed. In some cases, the QoS delivered by a service instance may vary over time because of the changes in the quality of supporting resources and/or because of governing policies. Grid clients, however, expect a certain minimum level of guarantees in the level of service delivered. These minimum levels may vary from one grid client to next and from one type of service to another. Nevertheless, it is important to be able to deliver a grid service with a predetermined level of quality.

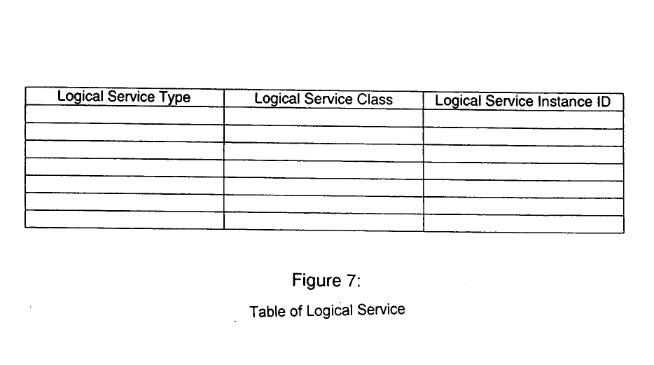

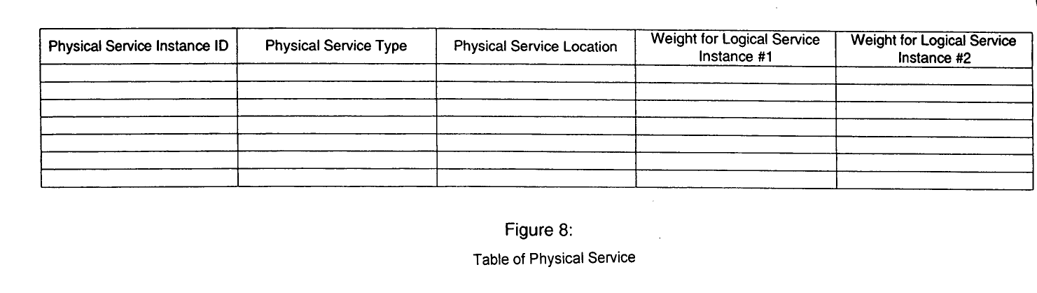

The mechanisms used for servicing the grid client requests with a high degree of confidence in meeting predetermined levels in the quality-of-service delivered, while using physical service instances that individually cannot meet the quality-of-service requirements with the same level of confidence is explained using FIGS. 7 and 8.

Services offered by the grid, collectively referred to as “grid services,” are classified into multiple types. These are listed in the first column of the table shown in FIG. 7. Each such type of request may be offered with multiple levels of minimum assured quality of service. For example, one type of grid service may provide timecard service; another type of grid service may provide payroll service; and yet another type of grid service may provide general employee information.

In the case of timecard service, a client request includes employee number and timecard information for that employee for each day of a week. When the request is processed, that employee's permanent records are updated. In the case of payroll service, a client request includes employee number and dates for which the payroll is to be processed. When the request is processed, payroll and timecard related records for that employee are accessed and amount to be paid is computed based on the number of hours worked and the rate of pay for that employee. The amount is deposited electronically to the employees bank account. In the case of the grid service that provides employee information, employee number is provided in the client request and service then accesses employee records and returns information about employee's name, home address, and manager's name.

In the example described above, it is submitted that the clients of each type of service have different levels of expectations about the quality of service delivered. In the case of the timecard service and the payroll service, it is important that each client request is processed within a certain prescribed amount of time. However, the two services may have different limits. While this is not so critical in the case of the employee information service, it needs to return the requested information within a certain time interval, if the payroll service accesses the employee information service. Thus, each type of service may be associated with one or more levels of service guarantees. Each such level is referred to as a class. Thus, in the above example, the employee information service may be associated with two classes-premier class and regular class. When premier class of this service is invoked, minimum service guarantees are more stringent than those associated with the regular class.

In the table shown in FIG. 7, each type of service is associated with one or more class types. These class types are listed in the second column of FIG. 7.

When multiple requests from clients arrive for the same type of service belonging to the same class, these may be serviced by the same service instance. However, there is a limit on the number of requests that can be assigned to a single service instance. This limit depends on the QoS attributes of the service instance.

For example, the service time of the service instance may limit the number of client requests that can be assigned to that service instance at any given time. When the client requests arrive at a rate higher than the rate at which they can be served by a service instance, additional service instances have to be deployed to keep up with the requests and meet the minimum service guarantees. Each such service instance is enumerated with a unique ID. These are listed in the last column of the table in FIG. 7. Notice that for each type of service, there may be one or more classes and for each class there may be one or more service instances deployed.

As mentioned earlier, the service instances listed in the FIG. 7 are expected to deliver service with certain minimum quality levels. All service instances belonging to a certain service class of a given service type are identical in this respect. For that reason these are referred to as logical service instances.

FIG. 8 is a table that associates the aforementioned logical service instances with the physical service instances described earlier.

Each physical service instance deployed by tGRM is assigned a unique ID. These instances are listed by their ID in the first column of the table in FIG. 8. The second column of FIG. 8 lists the type of the service for the service instance listed in the first column. Listed in the third column is the location for the service instances. The location is specified using the IP address of the Virtual Machine in which the physical service is deployed.

The remaining columns in the table of FIG. 8 list the weights computed by tGRM for each service type. The table has one column for each logical service instance listed in the table of FIG. 7. The weights for a physical service instance are all zero in columns corresponding to logical service instances of type other than the type of the physical service instance. For logical and physical service instances of the same type, the weights are computed by solving an optimization problem. The objective of the optimization problem is to satisfy the requirements of all deployed logical instances of a given type using a minimum number of physical service instances of the same type. One constraint is that there should be enough physical instances assigned to each logical instance so that the weights in each logical instance column add up to 1. Similarly, the weights associated with each physical instance (i.e., the weights in a row of the table) add up to one, but only if the QoS of the physical instance is consistent and highly reliable; i.e., if it is able to deliver at its potential capacity. For each degree of uncertainty associated with the predicted QoS of a physical service instance, this sum of the weights (i.e., its capacity) is reduced by a certain factor. Another constraint is that the physical instances be matched with logical instance of similar QoS requirements. In other words, a higher weight is desired for a high QoS physical instance in a column corresponding to high QoS logical instance. The weights should be lower in cases whenever there is a high degree of mismatch between QoS values of logical and physical instances.

The optimization problem does not need to be solved exactly and may be solved using heuristic methods. One optimization problem is solved for each type grid service and for each time interval for which predictions are available. Furthermore, the optimization problem is recomputed whenever QoS predictions are updated or whenever new logical or physical service instances are deployed.

The above described optimization problem may be cast as min-cost flow problem. In particular, it can be modeled as the well-known Hitchcock Problem. For a description of a typical method for solving the Hitchcock problem which can be used, see the algorithms described in Combinatorial Optimization: Algorithms and Complexity, Christos H. Papadimitriou and Kenneth Steiglitz, Prentice-Hall, 1982, the contents of which are hereby incorporated by reference herein. Obviously, other methods known to those skilled in the art can also be used.

The computed weights described above are used by the Grid Service Request Processor (GSRP) whenever a grid client request is to be routed to a physical service instance that is already deployed. FIG. 9 shows the details of GSRP. Grid client requests are first authenticated by Request Authenticator (610). These requests are then handled by Request State Handler (RSH) (620), which takes into account the type and the class of the service requested by the client and assigns that request to a logical service instance. If such a logical service instance is already defined in the Table of logical services (600), then the next step is to determine the physical service instance to use. If none of the existing logical service instances meets the requirements of the request, a new logical service instance is instantiated and GSRP waits for tGRM to compute the weights needed for performing a mapping from the logical service instance to a physical service instance.

To determine the actual physical service instance to use, GSRP looks up the Table of physical services (500) to obtain the weights listed in the column corresponding the selected logical service instance. One can use these weights as the probability distribution for mapping logical to physical instances. That is, the selection process is equivalent to random selection in which the probability of selecting the ith physical instance is proportional to the weight associated with physical instance i. RSH (620) selects one of the physical instances to assign the request for processing. From the Table of physical services (500) it obtains the location of the physical instance and routes the request via the Request Router (630). Internally, RSH (630) marks the request as “assigned” and stores the information about the request under an internal representation of the physical instance to which the request is assigned.

Request Router (630) routes the request to the assigned physical service instance after modifying the request so the response is returned to the Request Router (630) after it is processed. When the response arrives back at the Request Router (630), it resets the response to return it to the original grid client who had sent the request in the first place. The response is then returned back to the grid client. The state of the request stored in RSH (620) is updated to “processed.”

If the assigned physical service instance fails to process the request within a reasonable amount of time, one of the two things happen: (1) If the physical service is no longer providing service because of local policies, tGRM is informed about this change in status through the grid resource management hierarchy. This results in an update to the Table of physical services (500) and an event being sent GSRP about the change. GSRP then reassigns a new physical instance to that requests and the process is repeated. (2) RSH (620) times out and reassigns the request to another physical service instance using the Table of physical services (500). If a response arrives from the originally assigned physical instance, that response is dropped.

It can be seen that the description given above provides a simple, but complete implementation of a system that allows provisioning of grid services using shared resources that are governed by individual policies. Means have been described for predicting the state of the shared resources in the future using current and past event history. Means have been described for predicting the quality of service of the physically deployed service instances. Means have been described for reducing the inaccuracies in the predictions about the availability and the quality of service of the deployed service instances. Means have been described for providing minimum quality of service guarantees to grid clients by using logical service instances and then mapping those onto physical service instances with lower certainties about their actual deliverable quality of service. Means have been described to minimize the over provisioning of the physical services by formulating and solving an optimization problem.

Although the invention has been described using a single Grid Service Request Processor, that is not a limitation of the invention. Multiple GSRPs may be deployed to keep the Grid system scalable. When multiple GSRPs are deployed, a network dispatcher such as IBM Network Dispatcher may be used to choose one of the GSRPs to route a grid client request. (IBM Network Dispatcher is a component of IBM WebSphere Edge Server.) Grid resource managers need not run on dedicated servers, but can run on the resources provided by the grid itself. The Logical and Physical Resource Tables may be part of GSRP or part of tGRM or may be accessible from standalone components. The grid application in a virtual machine may run in side a web application server such as IBM WebSphere Application Server or it may be a standalone application that can be deployed on demand. An embodiment of GSRP can be provided using IBM WebSphere Portal Server or any other Web application server or by a standalone system.

The grid services may be modeled as web services and grid clients may access these services using SOAP over HTTP. The grid services could also be modeled as any service that can be accessed remotely using any client-server technology. The access protocol need not use SOAP over HTTP.

What we claim and desire to protect by Letters Patent is:

1. A system for implementing policy-based hierarchical management of shared resources in a grid environment whereby a grid management system is formed having architecture comprising: a set of shared resources; a hierarchy of resource managers formed by first-level resource managers; intermediate-level grid resource managers (iGRM); a top level grid resource manager (tGRM); a listing of service instances that are currently deployed on grid resources and the attributes of the said service instances; a listing of service instances created to satisfy grid client requests and the attributes of said service instances; and grid service request processor; said set of shared resources being interconnected with one another and with other elements comprising said structure via a computer network.

2. The system defined in claim 1 wherein said first level resource manager is part of a hierarchical grid management infrastructure in said system and provides policy management and control at said resource level.

3. The system defined in claim 2 wherein said first-level resource manager, within the system, monitors the state of local resources, gathers policy related data, performs analysis and communicates data and results from said analysis to a resource manager at a next level of management hierarchy.

4. A system for implementing policy-based hierarchical management of shared resources in a grid environment whereby a grid management system is formed having architecture comprising: a set of shared resources; a hierarchy of resource managers formed by first-level resource managers; a top level grid resource manager; a listing of service instances that are currently deployed on grid resources and the attributes of the said service instances; a listing of service instances created to satisfy grid client requests and the attributes of said service instances; and grid service request processor; said set of shared resources being interconnected with one another and with other elements comprising said structure via a computer network; and said first level managers communicate directly with a top level grid resource manager.

5. The system defined in claim 1 wherein the number of intermediate levels in the hierarchy and the number of lower-level resource managers connected to a iGRM or to a tGRM is a function of the amount of data to be analyzed at each level and the time required to analyze said data.

6. The system defined in claim 5 wherein said hierarchical resource management system gathers and analyzes data related to the state of said resources and the policies defined by resource owners who analyze the monitored state data for identifying patterns and correlations in their behavior to forecast the state of each resource at various time intervals in the future.

7. The system defined in claim 4 wherein said hierarchical resource management system gathers and analyzes data related to the state of the resources and the policies defined by resource owners who analyze the monitored state data for identifying patterns and correlations in their behavior to forecast the state of each resource at various time intervals in the future.

8. The system defined in claim 1 wherein said listing of service instances that are currently deployed on grid resources and the attributes of the said service instances are represented in a data structure table which is referred to as a Table of physical services.

9. The system defined in claim 7 wherein said listing of service instances that are currently deployed on grid resources and the attributes of the said service instances are represented in a data structure table which is referred to as a Table of physical services.

10. The system defined in claim 1 wherein said listing of service instances created to satisfy-grid client requests and the attributes of said service instances are represented in a data structure table which is referred to as a Table of logical services.

11. The system defined in claim 7 wherein said listing of service instances created to satisfy-grid client requests and the attributes of said service instances are represented in a data structure table which is referred to as a Table of logical services.

12. The system defined in claim 1 wherein said listing of service instances that are currently deployed on grid resources and the attributes of the said service instances are represented in a data structure table which is referred to as a Table of physical services and said listing of service instances created to satisfy-grid client requests and the attributes of said service instances are represented in a data structure table which is referred to as a Table of logical services.

13. The system defined in claim 7 wherein said listing of service instances that are currently deployed on grid resources and the attributes of the said service instances are represented in a data structure table which is referred to as a Table of physical services and said listing of service instances created to satisfy-grid client requests and the attributes of said service instances are represented in a data structure table which is referred to as a Table of logical services.

14. A method for implementing the system and using the elements defined in claim 1 comprising:
a grid client sends a request to a single address (URL) regardless of the type of service said grid client is requesting or the quality-of-service said grid client expects; said request is received by a grid service request processor (GSRP); said request is authenticated; after authenticating said request, using a listing of logical service instances, GSRP assigns said request to one of the logical service instances that is capable of providing the requested type of service with the agreed upon quality of service; using a mapping function to map a logical service instance onto one of a plurality of physical service instances that are capable of providing said service; said physical service instances being listed in a Table of Physical Services, which also lists weights to be used by the mapping function in determining the actual physical service instance to use for servicing a request.

15. The method defined in claim 14 wherein said weights associated with said physical service instances are updated continuously by tGRM using the predictions about the state of the available resources, the resource related policies, the expected demand on the grid services, and the grid policies.

16. The method defined in claim 15 wherein when a new said request arrives, GSRP consults said Table of logical services and said Table of physical services and, using the mapping function, said GSRP decides on the actual physical service instance to use; then routes said request to that service instance, while maintaining the state of that request as “assigned.”

17. The method defined in claim 16 wherein after servicing said request, a reply is sent back to GSRP, which then returns the reply to the appropriate grid client after updating said request state, to “processed.”

18. The method defined in claim 17 in which said actual physical service instance does not process said request after said request is assigned, in such event, GSRP reassigns said request to another physical service instance that provides the same service and said request is continuously assigned until its state is changed to “proceed.”

19. A method for implementing the system and using the elements defined in claim 7 comprising:
a grid client sends a request to a single address (URL) regardless of the type of service they are requesting or the quality-of-service said grid client expects; said request is received by a grid service request processor (GSRP); said request is authenticated; after authenticating said request, using a listing of logical service instances, GSRP assigns said request to one of the logical service instances that is capable of providing the requested type of service with the agreed upon quality of service; a mapping function is used to map a logical service instance onto one of a plurality of physical service instances that are capable of providing said service; physical service instances are listed in a Table of Physical Services, which also lists weights to be used by the mapping function in determining the actual physical service instance to use for servicing a request.

20. The method defined in claim 19 wherein said weights associated with said physical service instances are updated continuously by tGRM using the predictions about the state of the available resources, the resource related policies, the expected demand on the grid services, and the grid policies.

21. The method defined in claim 20 wherein when a new said request arrives, GSRP consults said Table of logical services and said Table of physical services and, using the mapping function, said GSRP decides on the actual physical service instance to use; then routes said request to that service instance, while maintaining the state of that request as “assigned.”

22. The method defined in claim 21 wherein after servicing said request, a reply is sent back to GSRP, which then returns the reply to the appropriate grid client after updating said request state, to “processed.”

23. The method defined in claim 22 in which said actual physical service instance does not process said request after said request is assigned, in such event, GSRP reassigns said request to another physical service instance that provides the same service and said request is continuously assigned until its state is changed to “proceed.”

24. The system defined in claim 1 wherein said shared resource is a desktop-based resource comprising an interactive workstation which performs interactive computations, and when not in use for said interactive computations, and based upon governing policies, said interactive workstation participates in grid computations.

25. The system defined in claim 24 wherein the components of said interactive workstation comprise a host Operating System (Host OS) that supports one or more interactive applications, said Host OS also supports a hypervisor application, which hypervisor application in turn supports a virtual machine (VM); a Monitoring Agent; Policy Handler; said virtual machine contains a virtual machine Operating System (VM OS), which supports grid applications that handle grid workload; said VM OS also optionally supports Virtual Machine Manager (VMM) or Virtual Machine Agent (VMA) or both.

26. The system defined in claim 25 wherein said Host OS and said VM OS contain communications function permitting applications using Host OS and VM OS to communicate.

27. The system defined in claim 26 wherein said Monitoring Agent and said Policy Handler communicate with VMM/VMA.

28. The system defined in claim 27 wherein said Host OS and VM OS contain communications means permitting applications using said Host OS and said VM OS to communicate.

29. The system defined in claim 28 wherein said Monitoring Agent and said Policy Handler possess means to communicate with said VMM/VMA running inside said VM.

30. The system defined in claim 29 wherein said Monitoring Agent, said Policy Handler and said VMM/VMA communicate with Grid Applications and with the rest of said grid resource management system and said Grid Service Request Processor.

31. The system defined in claim 30 wherein said Monitoring Agent uses functions and facilities of said Host OS and obtains information about the utilization of elementary resources in said desktop system by all software components supported by said Host OS.

32. The system defined in claim 31 wherein said elementary resources comprise CPU, memory, pages in said memory, hard drive and network.

33. The system defined in claim 25 wherein policies governing how said resources from said interactive desktop system are to be shared by said grid computations are set in said Policy Handler interactively by a desktop user, by an administrator or by a computer program.

34. The system defined in claim 32 wherein said information gathered by said Monitoring Agent depends on policies enforced by said Policy Handler.

35. The system defined in claim 34 wherein said Monitoring Agent communicates the monitored state information to Policy Handler and to VMM.

36. The system defined in claim 35 wherein said Policy Handler evaluates local policies using current state information and at the time when the current state of a monitored resource crosses a threshold as defined by a policy, said Policy Handler issues a command to VMM.

37. The system defined in claim 36 wherein, depending upon said policy, the command requires said VMM to stop participating in grid computations altogether or to stop deploying certain types of grid services or to reduce the usage of a particular resource.

38. The system defined in claim 37 wherein said Policy Hander directs said policy decisions to said VMM, which evaluates the policies and enforces them.

39. The system defined in claim 25 wherein said interactive workstation supports a plurality of hypervisors, each of which supports at least one or more virtual machines.

40. The system defined in claim 25 wherein said first level resource manager comprises Monitoring Agent, Policy Handler, VMM and Virtual Machine Agents.

41. The system defined in claim 1 which further comprises server resources, suitable for being shared among multiple grids, comprising Monitoring Agent means, Policy Handler means, and Virtual Machine Manager (VMM) means, the said means all embodied in a separate Virtual Machine with its own Virtual Machine OS.

42. The system defined in claim 41 wherein using communication means of said VM OS, said resources communicate with other components outside of their VM.

43. The system defined in claim 42 wherein said server resources are shared among multiple grids by creating a separate VM, one for each grid.

44. The system defined in claim 43 wherein said VMs in said server are scheduled by the Virtual Machine Scheduler; each said VM contains a Virtual Machine Operating System (VM OS); each said grid VM has a Virtual Machine Agent (VMA), which communicates with VMM; and each grid VM also contains one or more grid applications, each supporting grid workload.

45. The system defined in claim 44 wherein policies governing how said server resources are to be shared among multiple grids are set in Policy Handler, interactively by a server user, by an administrator or by a computer program.

46. The system defined in claim 41 wherein utilization of said resources by each said VM is monitored by said Monitoring Agent.

47. The system defined in claim 41, which further comprises a backend server, a web server or a grid server.

48. The system defined in claim 40 which comprise policy component means, policy analyzer means, monitoring agent means, policy enforcer means, event analyzer and predictor means, which in combination, develop a collection of information which is sent to the next higher level.

49. The system defined in claim 48 in which said collection of information comprises resources, services, policies, event history and control delegation.

50. The system defined in claim 49 in which a plurality of 1^{st} level resource manager sends said collection of information to a single intermediate iGRM.

51. The system defined in claim 1 wherein said intermediate-level grid resource manager comprises a first policy aggregator and analyzer means which collects information originated at and provided by a set of said first level resource managers, and a first event analyzer, correlator and predictor means.

52. The system defined in claim 51 wherein said policy aggregator and analyzer means and said event analyzer, correlator and predictor means develop improved information relating to forecasts about future events affecting the performance of said shared resources and software components; pertinent events from lower level; policies from lower level which includes a separate group policy input component.

53. The system defined in claim 52 wherein said improved information is forwarded to said top-level grid resource manager comprising a second policy aggregator and analyzer means which collects information originated at and provided by said intermediate level resource managers, and a second event analyzer, correlator and predictor means; quality of service (QoS) forecaster and mapper means; and grid policies and service request component means.

54. The system defined in claim 53 wherein said quality of service forecaster and mapper means applies policies applicable on said system for the corresponding time interval and computes the predicted state of each said shared resource on that system for that time interval.

55. The system defined in claim 54 wherein said predicted states determine a quality of resource (QoR) at a future time.

56. The system defined in claim 55 wherein said QoS forecaster and mapper makes projections about future requests from grid clients for each type of grid service.

57. The system defined in claim 56 wherein said projections include projections about arrival rates and the expected quality of service by each arriving request.

58. The system defined in claim 57 wherein an attribute of QoS is a response time that is taken to process and send back a response after receiving a request.

59. The system defined in claim 58 wherein, based upon said projections, said QoS forecaster determines the number of service instances of that type of service to deploy.

60. The system defined in claim 59 wherein said determination is done for each time interval for which said QoS forecaster has relevant data available.

61. The system defined in claim 60 wherein for each service instance to deploy, said QoS selects appropriate resources based upon the requirements of said service as well as the availability of said resource to run that service during a given time interval.

62. The system defined in claim 61 wherein in order to deploy services instances on selected actual physical resources by said QoS forecaster and mapper issues commands.

63. The system defined in claim 62 wherein said commands are transmitted down said resource management hierarchy and are ultimately executed by VMAs or VMMs on a virtual machine.

64. The system defined in claim 63 wherein said QoS forecaster and mapper computes a set of weights for each said physical service instance.

65. The system defined in claim 64 wherein said weights in said Table of physical services are computed by solving an optimization problem for logical and for physical service instances of the same type.

66. The system defined in claim 12 wherein said requested type of service is handled by a Request State Handler (RSH), which takes into account the type and class of said service requested by a client, and assigns that request to a logical service instance.

67. The system defined in claim 66 wherein said RSH selects one of the physical instances to assign the request for processing using weights, developed by the GSRP from said listing of service instances that are currently deployed on grid resources and the attributes of the said service instances, as the probability distribution for mapping logical to physical instances.

68. The system defined in claim 13 wherein said shared resource is a desktop-based resource comprising an interactive workstation which performs interactive computations, and when not in use for said interactive computations, and based upon governing policies, said interactive workstation participates in grid computations.

69. The system defined in claim 68 wherein the components of said interactive workstation comprise a host Operating System (Host OS) that supports one or more interactive applications, said Host OS also supports a hypervisor application, which hypervisor application in turn supports a virtual machine (VM); a Monitoring Agent; Policy Handler; said virtual machine contains a virtual machine Operating System (VM OS), which supports grid applications that handle grid workload; said VM OS also optionally supports a Virtual Machine Manager (VMM) or a Virtual Machine Agent (VMA) or both.

70. The system defined in claim 69 wherein said Host OS and said VM OS contain communications function permitting applications using Host OS and VM OS to communicate.

71. The system defined in claim 70 wherein said Monitoring Agent and said Policy Handler communicate with VMM/VMA.

72. The system defined in claim 71 wherein said Host OS and VM OS contain communications means permitting applications using said Host OS and said VM OS to communicate.

73. The system defined in claim 72 wherein said Monitoring Agent and said Policy Handler possess means to communicate with said VMM/VMA running inside said VM.

74. The system defined in claim 73 wherein said Monitoring Agent, said Policy Handler and said VMM/VMA communicate with Grid Applications and with the rest of said grid resource management system and said Grid Service Request Processor.

75. The system defined in claim 74 wherein said Monitoring Agent uses functions and facilities of said Host OS and obtains information about the utilization of elementary resources in said desktop system by all software components supported by said Host OS.

76. The system defined in claim 75 wherein said elementary resources comprise CPU, memory, pages in said memory, hard drive and network.

77. The system defined in claim 69 wherein policies governing how said resources from said interactive desktop system are to be shared by said grid computations are set in said Policy Handler interactively by a desktop user, by an administrator or by a computer program.

78. The system defined in claim 76 wherein said information gathered by said Monitoring Agent depends on policies enforced by said Policy Handler.

79. The system defined in claim 78 wherein said Monitoring Agent communicates the monitored state information to Policy Handler and to VMM.

80. The system defined in claim 79 wherein said Policy Handler evaluates local policies using current state information and at the time when the current state of a monitored resource crosses a threshold as defined by a policy, said Policy Handler issues a command to VMM.

81. The system defined in claim 80 wherein, depending upon said policy, the command requires said VMM to stop participating in grid computations altogether or to stop deploying certain types of grid services or to reduce the usage of a particular resource.

82. The system defined in claim 81 wherein said Policy Hander directs said policy decisions to said VMM, which evaluates the policies and enforces them.

83. The system defined in claim 69 wherein said interactive workstation supports a plurality of hypervisors, each of which supports at least one or more virtual machines.

84. The system defined in claim 69 wherein said first level resource manager comprises Monitoring Agent, Policy Handler, VMM and Virtual Machine Agents.

85. The system defined in claim 13 which further comprises server resources, suitable for being shared among multiple grids, comprising Monitoring Agent means, Policy Handler means, and Virtual Machine Manager (VMM) means, said means all embodied in a separate Virtual Machine with its own Virtual Machine OS.

86. The system defined in claim 85 wherein using communication means of said VM OS, said resources communicate with other components outside of their VM.

87. The system defined in claim 86 wherein said server resources are shared among multiple grids by creating a separate VM, one for each grid.

88. The system defined in claim 87 wherein said VMs in said server are scheduled by the Virtual Machine Scheduler; each said VM contains a Virtual Machine Operating System (VM 0S); each said grid VM has a Virtual Machine Agent (VMA), which communicates with VMM; and each grid VM also contains one or more grid applications, each supporting grid workload.

89. The system defined in claim 88 wherein policies governing how said server resources are to be shared among multiple grids are set in Policy Handler, interactively by a server user, by an administrator or by a computer program.

90. The system defined in claim 85 wherein utilization of said resources by each said VM is monitored by said Monitoring Agent.

91. The system defined in claim 85, which further comprises a backend server, a web server or a grid server.

92. The system defined in claim 84 which comprise policy component means, policy analyzer means, monitoring agent means, policy enforcer means, event analyzer and predictor means, which in combination, develop a collection of information which is sent to the next higher level.

93. The system defined in claim 92 in which said collection of information comprises resources, services, policies, event history and control delegation.

94. The system defined in claim 13 wherein said requested type of service is handled by a Request State Handler (RSH), which takes into account the type and class of said service requested by a client, and assigns that request to a logical service instance.

95. The system defined in claim 94 wherein said RSH selects one of the physical instances to assign the request for processing using weights, developed by the GSRP from said listing of service instances that are currently deployed on grid resources and the attributes of the said service instances, as the probability distribution for mapping logical to physical instances.

96. A system for enabling policy based participation of desktop PCs in grid computations, comprising articles of manufacture which comprise computer-usable media having computer-readable program code means embodied therein for enabling said desktop PCs for policy-based participation in grid computations:
said computer readable program code means in a first article of manufacture comprising a host operating system having readable code means for causing a computer to manage desktop PC resources comprising memory, disk storage, network connectivity, and processor time and said wherein code means provides an application programming interface (API) for applications to request and use said resources;
said computer readable program code means in a second article of manufacture comprising a first-level resource manager having readable program code means for:
causing a computer to receive policy rules and parameters from computer users, administrators, and computer programs; for analyzing said policy rules and parameters;
for monitoring the state of the resources and programs on the said desktop according to the said policy rules and parameters;
for enforcing participation and usage of the said desktop resources in grid computations;
for analyzing events affecting desktop resources and predicting resource state at multitude of future time intervals;
for communicating changes in the policy rules and parameters, recent event history, and control information to a higher level grid resource management software;
said computer readable program code means in a third article of manufacture comprising an intermediate-level grid resource manager having readable program code means for:
causing a computer to receive group policy rules and parameter from computer users, administrators, and computer programs;
for receiving changes in policy rules and parameters from a multitude of first-level resource managers;
for receiving changes in policy rules and parameters from a multitude of intermediate-level grid resource managers;
for aggregating policy rules and parameters received from a multitude of lower-level grid resource managers and the group policy rules and parameters and analyzing these aggregated policy rules and parameters;
for receiving event history related to desktop resources from a multitude of first-level resource managers;
for receiving event history related to desktop resources from a multitude of intermediate-level grid resource managers;
for receiving forecasts about future events affecting desktop resources from a multitude of first-level resource managers;
for receiving forecasts about future events affecting desktop resources from a multitude of intermediate-level grid resource managers;
for analyzing and correlating events received from lower-level grid resource managers and using this analysis for predicting the future state of the desktop resources at multitude of future time intervals;
for communicating changes in the individual and group policy rules and parameters, recent event history, and control information to a higher level grid resource management software;
said computer readable program code means in a fourth article of manufacture comprising a top-level grid resource manager having readable program code means for:
causing a computer to receive group policy rules and parameter from computer users, administrators, and computer programs;
for receiving changes in policy rules and parameters from a multitude of first-level resource managers;
for receiving changes in policy rules and parameters from a multitude of intermediate-level grid resource managers;
for aggregating policy rules and parameters received from a multitude of lower-level grid resource managers and the group policy rules and parameters and analyzing these aggregated policy rules and parameters;
for receiving event history related to desktop resources from a multitude of first-level resource managers;
for receiving event history related to desktop resources from a multitude of intermediate-level grid resource managers;
for receiving forecasts about future events affecting desktop resources from a multitude of first-level resource managers;
for receiving forecasts about future events affecting desktop resources from a multitude of intermediate-level grid resource managers;
for analyzing and correlating events received from lower-level grid resource managers and using this analysis for predicting the future state of the desktop resources at multitude of future time intervals;
for receiving grid policies, grid client service level agreements, grid client request history, and the quality of service delivered to grid clients;
for applying the desktop resource related individual and group policies to the predicted resource states at multitude of future time intervals and for computing the availability states of these resources and for computing the normalized quality of the said resources for performing grid computations at corresponding time intervals in the future;
for predicting the future request patterns from grid clients and for predicting the quality of service requirements for each type of grid service offered to meet the future demands from grid clients;
for instantiating a sufficient number of logical service instances each with a certain expected quality of service attribute to meet the expected demand from grid clients in each future time interval;
for instantiating a sufficient number of physical service instances to meet the future demand from grid clients;
for computing a set of weights associated with each physical service instance that are to be used in selecting that service instance when processing a grid client request by applying a mapping from logical service instance to a physical service instance;
said computer readable program code means in a fifth article of manufacture comprising a grid service request processor having readable program code means:
for authenticating grid client requests;
for identifying service type and quality of service requested by each grid client request;
for assigning a grid client request to a logical service instance;
for mapping the logical service instance to physical service instance using the weights computed by the top level grid resource manager, on a per grid client request basis;
for routing the grid client request to the desktop where the assigned physical service instance is deployed;
for receiving the response from the physical service instance and returning it to the appropriate grid client;
for reassigning the grid client request to another physical service instance in case the already assigned physical service instance does not respond within a specified time interval;
